(19) United States
(12) Patent Application Publication
(10) Pub. No.: US 2011/0184692 A1
(43) Pub. Date: Jul. 28, 2011

(54) SYSTEM AND A METHOD FOR SPATIAL ESTIMATION AND VISUALIZATION OF MULTI-LEAD ELECTROCARDIOGRAPHIC ST DEVIATIONS

(75) Inventor: Mads Peter Andersen, Aalborg OEst (DK)

(73) Assignee: AALBORG UNIVERSITET, Aalborg OE (DK)

(21) Appl. No.: 13/122,442

(22) PCT Filed: Oct. 2, 2009
(86) PCT No.: PCT/DK09/50260

§ 371 Date: Apr. 14, 2011

(30) Foreign Application Priority Data
Oct. 3, 2008 (DK) PA 2008 01397

(51) Int. Cl. G06F 15/00

(52) U.S. Cl. 702/155

(57) ABSTRACT

A system and a method for spatially ordered estimation and visualization of multi-lead electrocardiographic ST deviations induced by myocardial ischemia, in which system a plurality of ECG signals are recorded from a ECG source, which signals are stored by a processor in a memory, which processor processes the signals to obtain ST deviation, which processor performs measurement of ST deviation from each lead where the processor performs a multi-dimensional estimation of an vector representing of the spatial direction and magnitude of the underlying cardiac injury-current giving rise to the measured ST deviations, which processor hereby estimates the spatial location and severity of myocardial ischemia.

### BACKGROUND OF THE INVENTION

1. Field of the Invention

The present invention relates to a system and a method for spatial estimation and visualization of multi-lead electrocardiographic ST deviations induced by myocardial ischemia, in which system a plurality of ECG signals are recorded from a ECG source, which signals are stored by a processor in a memory, which processor processes the signals to obtain ST deviation, which processor performs measurement of ST deviation from each lead.

2. Description of Related Art

Electrocardiographic recordings (ECG) are made by means of electrodes on the limbs and torso of a person or animal connected to an electrocardiographic apparatus to amplify and possibly filter and store the signal in digital format. The signals can then be graphically displayed and visually interpreted as well as analyzed in a computer unit.

By using several electrodes at different body positions, it is possible to obtain several different ECG recordings simultaneously. Each of these recordings is called a lead and represents a spatial projection of the electrical activity of the heart onto a vector defined by the lead direction, which is determined by the position of the electrode(s) used for the lead. In a typical 12-lead standard ECG, electrodes placed on the limbs give rise to the limb leads (I-III) and augmented leads (aVR-aVF) oriented in the frontal plane, and electrodes placed on the torso give rise to the precordial leads oriented in the horizontal plane (V1-V6). The typical graphical display of the 12 standard leads follows the order I, II, III, aVR, aVL, aVF, V1, V2, V3, V4, V5, V6.

The most common perception of the electrical activity of the heart is a number of three-dimensional loops, indicating that the electrical propagation wavefront changes spatial direction and magnitude throughout the cardiac cycle. Following this reasoning each lead is a two-dimensional projection of these three-dimensional loops. Different parts of the ECG (called ‘waves’ or ‘segments’) represent different parts of the cardiac activation cycle. As shown in FIG. 1, the common nomenclature is P, Q, R, S, T and U.

The part of the ECG between the end of the S wave and the beginning of the T wave is called the ST segment. The ST segment is of special interest for the diagnosis of myocardial ischemia (lack of oxygen supply to the cardiac muscle) and related conditions. Under normal, healthy conditions the ST segment should approximate an isoelectric line at zero voltage. Any deviation from zero is called ST deviation. If the value is larger than zero, it is called ST elevation, and any value smaller than zero is called ST-depression. The ST deviation can be measured at different points along the ST segment according to a given definition. According to the latest consensus standards (1) the ST deviation should be measured at the junction point immediately following the S wave. This point is called the J-point as shown in FIG. 1.

The importance of the ECG in diagnosis of acute cardiac ischemia (called ‘myocardial infarction’) is underlined by the nomenclature used to categorize the severity of the disease: ‘ST elevation myocardial infarction (STEMI)’ and ‘non-ST-elevation myocardial infarction (non-STEMI)’ based on measurements of ST-segment deviation on the surface ECG. Determination of the state ‘STEMI’ or ‘non-STEMI’ is important for the correct choice of treatment. In clinical practice, the fulfillment of well-defined STEMI criteria (1) determines whether the patient is diagnosed as ‘STEMI’ or ‘non-STEMI’ and the choice of treatment is made accordingly. To fulfill the current criteria for ‘STEMI’ the ECG must show ST segment elevation in two spatially contiguous leads of at least 0.1 mV (0.2 mV in the precordial leads V2-V3). If the STEMI criteria are not fulfilled, the patient is categorized in the broad ‘non-STEMI’ group.

However, recent publications in the field of electrocardiography have questioned the strict distinction between STEMI and non-STEMI on two key points. The usual print order of the frontal leads follows a non-sequential order with respect to spatial contiguity, which makes it difficult to determine the lead contiguity criteria. Also, only ST elevation and not ST depression is considered indicative of myocardial infarction in the criteria. However, it is known that posterior infarctions may only appear as ST depression in the precordial leads. Following the criteria a large number of posterior myocardial infarctions may be missed.

Looking at the basic theory of electrocardiography, ST deviations is caused by underlying cardiac injury currents in the setting of myocardial ischemia. A review of this theory published by J Hurst (2, 3) states that ST deviations are projections of an ST injury current vector created by areas of myocardial ischemia, which adds to the normal electrical activity of the heart. If the ST injury current flows towards the positive pole of a lead (typical for anterior infarctions), ST elevation will be measured. If the same injury current flows towards the negative pole of a lead (typical for posterior infarctions), ST depression will be measured in the lead. Following this reasoning a myocardial infarction may give rise to either ST elevation or ST depression depending on the lead used to measure the phenomenon and the location of the ischemic area. Hence, a more correct diagnosis of myocardial infarction may be obtained by considering ST depression and ST elevation as equivalent electrical phenomena arising from one underlying ST injury current vector. Estimating the ST injury current vector may allow for a more correct diagnosis of myocardial infarction, independent of the lead set used and the location of the ischemic area.

Further research suggests that the spatial distribution of ST deviations may be used to discriminate between STEMI or a true non-STEMI condition, which is important to determine the best choice of treatment. If the ST deviations form a distinct pattern that may be explained by a single ST injury current vector, it may be indicative of STEMI. If the ST deviations form a more diffuse pattern that is not as easily described with a single ST injury current vector, this may be indicative of a true non-STEMI condition (4). Further research indicates that a superior-septal direction of the ST injury current vector may be specific for the true non-STEMI condition.

Determining the spatial direction and magnitude of the ST injury current vector from a standard ECG display or printout requires great skills and experience. The ST deviation measurement in each lead represents a projection of the ST injury vector in a given direction in space and it is intellectually challenging to handle and combine several lead directions at once to form a spatial estimate of the ST injury current vector.

Visualizing and interpreting the ECG with a vectorial approach as recommended by J Hurst may be useful for determining the ST injury vector, hereby facilitating a more reliable diagnosis of myocardial infarction. With a vectorial approach each ST deviation is considered a spatial vector with magnitude and direction. The most well-known technique to facilitate a vectorial approach in the analysis of electrocardiographic recordings is vectorcardiography (VCG), where the electrical activity of the heart is displayed in three orthogonal dimensions (XYZ). In principle, this allows for direct spatial estimation of the ST injury current vector. However, none of the VCG-based techniques have achieved widespread clinical use due to severe practical drawbacks in comparison with the standard 12-lead ECG.

International Patent Application Publication WO 00014687 describes a cardiographic display for displaying an electrocardiograph heart signal in vector format within a single three-dimensional coordinate system sampled at incremental time intervals and combining the above vector display on the same screen with other displays, e.g., a 12-Lead display. Other embodiments of the invention comprise projecting the results of the heart vector onto three planes of the coordinate system which represent the frontal, transverse and sagittal planes while simultaneously displaying the three-dimensional vector display. Still other embodiments comprise combining the three-dimensional with various graphs which show the various changes in magnitude and angle between the heart vectors.

U.S. Patent Application Publication 2006/0258947 describes a medical display for analyzing heart signal, which includes a cardiographic display which displays an electrocardiograph (ECG) heart signal segment of a patient having magnitude and location in vector format within a single three-dimension (3D) coordinate system (vectorcardiograph) sampled at incremental time intervals. The display communicates with a central processing unit (CPU) that implements an algorithm to permit a user to selectively and visually display a comparison of the patient ECG with at least one known display in vector format within a single three-dimensional (3D) coordinate system. The display also penults a user to selectively and visually convert and display an ECG heart signal segment into a color-coded projection of a time sequence. A method for analyzing heart signal includes implementing the algorithm to selectively and visually compare the ECG heart signal with at least one known display in vector format selected from the group.

International Patent Application Publication WO 2006/033038 describes a method of medical monitoring using data collected by a number of sensors, which are positioned on a patient in a way that the sensors form a predefined arrangement and the collected data depend on the position of the sensor on the patient. The method comprises the step—displaying data using a number of multi-axis diagrams in which the position of the axes is related to the position of the sensors in the predefined arrangement, and on each axis data from its related sensor is displayed.

International Patent Application Publication WO 2009/077915 A1 concerns an ECG monitoring system which analyzes ECG signals of leads associated with different anatomical locations of the body for evidence of ST elevation in the lead signals. The ST elevation and depression measurements of the leads are plotted in a graphical display organized in relation to the anatomical points which are the sources of the lead signals. The locations of the plotted measurements in the anatomically-oriented display indicate the identity of a specific coronary artery or branch as a possible culprit coronary artery for an acute ischemic event, as well as the possible severity of the event from the magnitudes of the plotted signals. A clinician can identify a suspect culprit coronary artery from a quick glance at the graphical display.

U.S. Pat. No. 5,419,337 describes an apparatus for the detection, recording and analysis of the electrical activity of a cardiac comprises an array of from 40 to 100 electrodes each capable of detecting an electrical signal associated with the ST component of a heartbeat. The array is connected to a microprocessor controlled interface which in turn is connected to a microprocessor controlled analyzer and display apparatus.

Both International Patent Application Publications WO 00/014687 and WO 2009/077915, and U.S. Patent 2006/0258947 describe vectorcardiographic displays. This technique enables the user to extract the magnitude and direction of the ST injury current vector from the three-dimensional display. However, to form the vectorcardiographic display, the user must use ECG recording methods that are impractical and unrecognized in the typical clinical setting.

The only widely accepted and used lead configuration for diagnosis of myocardial infarction is the standard 12-lead ECG recording, or a subset of this lead configuration (1). The diagnosis of myocardial infarction takes place immediately following a heart attack, on the scene, in the ambulance, in the emergency room or in a similar location. The ten electrodes used for 12-lead recordings can be placed quickly and effectively on the ankles, wrists and chest of the patient while lying down and do not require electrodes to be placed on the back of the patient.

One approach to obtain the XYZ signals for the vectorcardiographic display is the Frank lead configuration, where orthogonal XYZ leads are recorded directly from the patient. This lead configuration requires the placement of an electrode on the back of the patient, making it unsuited for emergency care. Another approach to obtain the XYZ signals is through mathematical transformation from the 12-lead recording to XYZ signals, e.g. the inverse Dower transformation (5). However, because of individual differences in body anatomy and size, the XYZ approximation is imprecise and does not offer the diagnostic accuracy required by the medical environment. Also, the mathematical transformation averages the recorded leads and may cancel out diagnostical relevant ST deviations.

The clinical resistance towards the use of vectorcardiographic methods for diagnosis of myocardial infarction is underlined by the fact that no VCG-based diagnosis criteria exist. This is only the case for 12-lead recordings.

The correct diagnosis and treatment of myocardial infarction is time-critical and the placement of a larger number of electrodes would significantly increase the time to treatment. The large number of electrodes required in U.S. Pat. No. 5,419,337 makes this technique unsuited for clinical use.

Recently, Swedish researchers have introduced a 24-lead ECG (6), where the 12 standard leads are recorded and complemented by their negative counter-part (i.e. −I, −II, −aVR etc.) and displayed around a torso model in two planes to indicate the spatial direction of the individual leads. The 24-lead ECG produces a spatially ordered ECG, covering the entire 360° arc of both the frontal and horizontal planes (6). In essence the 24-lead ECG provides a way of visualizing ECG waveforms in different directions in the horizontal and frontal planes, making it possible to extract the spatial distribution of ST deviations. However, the inverse waveforms are of little importance in the diagnosis of myocardial infarction as compared to the ST deviation measurements, the 24-lead ECG would require major changes in the current ECG print and display standards, and the presentation of ST deviations can be made more informative and concise using a vectorial approach. Finally, the 24-lead ECG does not present an overall estimation of the ST injury current vector, still demanding the user to form this vector mentally.

### SUMMARY OF THE INVENTION

The object of the invention is on the basis of standard ECG recordings (such as the 12-lead configuration) to graphically display measured ST deviations from multiple leads as spatially ordered vectors. A further purpose of the invention is to estimate the underlying ST injury current vector that best explains the measured ST deviations and to evaluate how well the single ST injury current vector explains the observed ST deviations and to graphically display the estimated ST injury current vector as an indicator of the extent and location of myocardial ischemia allowing for fast, easy and accurate diagnosis of myocardial infarction and related conditions.

### DESCRIPTION OF THE INVENTION

This object can be achieved by a system of the type described above if further modified so that the signals are stored and processed to obtain ST deviation measurements from each lead and where these measurements are used to form a graphical display of vectors representing the magnitude of each ST deviation in the spatial direction of the lead from which the measurement was made.

Furthermore, the ST deviation measurements are processed to estimate an overall ST injury current vector that numerically fits the single ST deviation vectors, when the single ST deviation vectors are considered projections of the overall ST injury current vector onto vectors in the spatial direction of each single lead, and where the degree to which the ST injury current vector estimate explains the observed ST deviation vectors is evaluated and where the ST injury current vector estimate is displayed to indicate the extent and location of myocardial ischemia.

Hereby, it is achieved that any symptom of a disease having an indication (influence) in the ST segment of the ECG curvature can be detected in an objective, automated and very fast way. The system may be used under field conditions such as in ambulances or in other situations where a fast indication of heart disease is needed in order to help the patient in a correct way as early as possible. The analysis that takes place in an ambulance on its way to the hospital can, by transmitting the results to the hospital, allow the doctor at the hospital to give feedback to the personnel in the ambulance so that the correct treatment of the patient may start. At the same time, the hospital can prepare the correct activity for the incoming patient. The system could be very important for ECG analyses for all non-specialists in the field if they have to analyse an ECG curvature for ST segment changes.

The system supports the clinical interpretation of ST segment changes by presenting ST deviation measurements as spatial vectors and estimating an overall ST injury current vector. This is well in line with the common clinical interpretation techniques; that ST deviation are caused by an underlying ST injury current, that the ST injury current flows towards areas of myocardial ischemia and that ST deviation in any lead indicates myocardial ischemia in an adjacent area of myocardium. Furthermore, the system supports the clinical diagnosis of true non-STEMI by evaluating the degree to which a single ST injury current vector can be used to explain the observed ST deviations. In this way the system may be very important for the diagnosis of myocardial ischemia.

The system offers a spatial/vectorial visualization of the electrical activity of the heart, much like the vectorcardiogram (VCG). In contrast to the VCG, the system is based on clinically accepted lead configurations and does not require electrodes to be placed on the back of the patient, which may be impractical when the patient is in supine position during transportation or treatment. Also the system does not require mathematical transformations that may average out diagnostical important ST deviations. Nor does the system require a large number of electrodes to be placed on the patient, which may be time-consuming and delay the correct diagnosis and treatment of the patient. In this way the system is fully compatible with existing and clinically used ECG recording techniques.

The ST deviation vectors and the overall ST injury current vectors may be displayed graphically in a two or three-dimensional form. The three-dimensional form may be well suited for software applications, where the user can turn and observe the vectors in space. The vectors may also be presented in a two-dimensional form, where the vectors are projected onto two two-dimensional planes, e.g. the frontal and horizontal planes of the body. The two-dimensional display form ensures compatibility with existing two-dimensional ECG media such as bedside monitors, emergency care equipment, electrocardiographs and on ECG print-outs, which are commonly used in clinical practice. The two-dimensional display may be displayed or printed in combination with existing displays and offer supplementary information without interfering with existing ECG print- and display standards.

By displaying ST deviation vectors in a spatially ordered fashion, the system facilitates the correct interpretation of lead contiguity in the interpretation of the ECG. Lead contiguity is a central aspect of the current diagnostic criteria for myocardial infarction, but the standard 12-lead ECG display does not offer an ordered display of spatially contiguous leads. By clarifying spatial contiguity of leads to the user, the system may improve the correct interpretation of ST deviations in the ECG with respect to diagnostic criteria and hereby improve the diagnosis of the disease.

The system can acquire a plurality of ECG recordings (leads) from the human body, store the signals and process the signals to measure the voltage level of the ST segment (ST deviation) of the ECG curvature in the J-point or any point along the ST segment.

The system can acquire existing ST deviation measurements from existing ECG systems to process these ST deviation measurements further.

The acquired ST deviation measurements may be used to form ST deviation vectors for each of the recorded leads and measured ST deviations. This can be done for each ST deviation measurement by defining the magnitude of the ST deviation vector as the size of the ST deviation on a continuous scale and by defining the direction of the ST deviation vector as the spatial direction of the lead in which the measurement was made.

The lead directions can be defined for any lead configuration based on torso geometry, experiments or conceptual definitions such as the Einthoven triangle. The direction of ST deviation vectors defined by positive ST deviation values (ST elevation) may be defined as a vector pointing towards the positive pole of the lead in question. The direction of ST deviation vectors defined by negative ST deviation values (ST depression) may be defined as a vector pointing towards the negative pole of the lead in question.

The ST deviation vectors may be displayed as coordinates, magnitude and angle or similar mathematical representation or displayed graphically in a two-dimensional or three-dimensional form.

The three-dimensional form may consist of a three-dimensional coordinate system where each ST deviation vector is displayed as an arrow pointing from the origin of the coordinate system in the direction and magnitude defined by its coordinates.

The two-dimensional form may consist of two two-dimensional coordinate systems where the two coordinate system covers two orthogonal planes, such as the frontal and horizontal planes that fully describe the entire three-dimensional character of the vectors. Each ST deviation vector may be projected onto each of the two planes covered by the two coordinate systems and displayed in each of the coordinate systems as an arrow pointing from the origin of the relevant coordinate system in the direction and magnitude defined by its projection coordinates.

To facilitate reading of the ST deviation vector magnitude each of the two- and three-dimensional coordinate system may include a scale. This scale may be displayed as concentric circles surrounding the origin of the coordinate system. The scale may be chosen to fit with the current diagnostic criteria for the disease in hand—such as millimeter scale or 100-microvolt scale for diagnosis of myocardial infarction. The display may also have direction labels to indicate the anatomical direction of each of the coordinate system axes, e.g. anterior, posterior, lateral, septal, superior and inferior.

The system may further process the ST deviation vectors to estimate an overall ST injury current vector to indicate the location and severity or extent of myocardial ischemia.

This may be done by estimating the overall ST injury current vector that best fits the ST deviation vectors, when each of the ST deviation vectors is considered a projection of the overall ST injury current vector in the direction of the lead used to form each ST deviation vector.

The estimation of the ST injury current vector may be done by mathematics by minimizing the difference between the actual ST deviation vectors obtained from actual ST deviation measurement and the projections of the ST injury current vector onto the relevant lead directions. This procedure for estimating the best fitting ST injury current vector is different from common vector calculation techniques for estimating the resulting vector of independent forces, since the relationship between the ST injury current vector and the ST deviation vectors is highly specific for the physiology of the ECG signals.

The operation may be performed in the following way:

The ST injury current vector is a single 3D vector that, when projected on each of the leads, best describes the observed ST deviation vectors in the leads. Mathematically, the lengths or amplitudes a of the observed ST deviation vectors can be calculated by projecting the ST injury current vector v on the respective lead vector lᵢ: αᵢ=v·lᵢ+eᵢ, where v·lᵢ is a scalar product (projection) of the ST injury current vector with the lead vector lᵢ, and eᵢ is an error term because a single ST injury current vector will not fit exactly all observed leads. v is now chosen such as to minimize the errors over all the leads to obtain the best fitting ST injury current vector. The calculations to obtain this vector may be the same as in a multiple regression or other optimization techniques.

The error terms for the best fitting ST injury current vector estimate may be used as an indicator of the degree to which the single ST injury current vector estimate can be used to explain the observed ST deviations. This can be done by evaluating the goodness-of-fit of the ST injury current vector with respect to the observed ST deviations. By defining a level of threshold the goodness-of-fit estimate may be used to categorize the condition as ‘normal’, ‘STEMI’, ‘true non-STEMI’ or similar. The goodness-of-fit estimate as well as the category label may be displayed graphically.

The ST injury current vector estimate may be displayed numerically or in a two- or three-dimensional fashion as described above for the display of ST deviation vectors. The display may contain scale and direction labels as described above for the display of ST deviation vectors. The display of the ST injury current vector may be done in the same coordinate system as the display of the ST deviation vectors to allow for direct comparison of the single ST deviation vectors and the overall ST injury current vector estimate.

Furthermore, the ST injury current vector estimate may be used to categorize the location and extent of myocardial ischemia. This may be done by defining a threshold for the magnitude of the ST injury current vector, which threshold can be used to categorize the condition indicated by the ST injury current vector as normal or indicative of a certain degree or extent of myocardial ischemia.

Furthermore, the direction of the ST injury current vector may be used to categorize the location of a possible ischemic area. This may be done by defining a number of direction zones in the relevant coordinate system used, to allow for anatomical positioning of the suspected ischemic myocardial area. One example of such a category could be ‘infero-lateral’ indicating that the ST injury current vector points in the direction zones defined as inferior and lateral, possibly indicating an area of suspected ischemic myocardium in this region.

Furthermore, the superior-septal direction of the ST injury current vector may be specific for a true non-STEMI condition and may be used to categorize the condition indicated by the ST injury current vector.

### BRIEF DESCRIPTION OF THE DRAWINGS

FIG. 1 shows an electrocardiographic display of a single heart beat.

FIG. 2 shows ST deviation measurements presented in a panel.

FIG. 3 shows the 3D ST injury vector v.

FIG. 4 shows results for a Case 1.

FIG. 5 shows results for a Case 2.

### DETAILED DESCRIPTION OF THE INVENTION

### Application Example

“ST Compass: Spatial visualization of ST segment deviation”

### Introduction:

The importance of the electrocardiogram (ECG) in the diagnosis of acute myocardial infarction (AMI) is underlined by the clinical definition of the AMI subgroups based on ECG-findings: ST elevation myocardial infarction (STEMI), Bundle Branch Block myocardial infarction (BBBMI) and non-ST elevation myocardial infarction (non-STEMI). Patients with signs of STEMI or BBBMI are triaged for acute reperfusion therapy to ensure maximal myocardial salvage and optimal outcome.

In clinical practice, the fulfillment of well-defined STEMI criteria (1) determines whether the patient is eligible for reperfusion therapy. The current criteria require ST segment elevation in two contiguous leads of at least 0.1 mV (0.2 mV in leads V2-V3 for men and 0.15 mV for women). If the STEMI criteria are not fulfilled, and newly or presumably newly developed bundle branch block is not present (BBBMI), then the patient is categorized in the broad non-STEMI group and reperfusion therapy is considered contraindicated (7).

In a recent publication, Wagner and co-workers identify a number of pitfalls in the current criteria for diagnosis of STEMI (7):

The non-sequential order of frontal leads makes it difficult to determine lead contiguity.

Only ST elevation and not ST depression is considered indicative of myocardial infarction, even though posterior infarctions may appear as ST depression in the anterior leads only.

A single diagnostic ST deviation threshold, independent of gender and age, is not sufficient.

The latter pitfall may be overcome by redefining the criteria through population studies. However, the two first pitfalls touch upon a fundamental problem in the current perception of ST deviation in the electrocardiogram. The current STEMI criteria are based on clinical experience from flat paper tracings and ignore the spatial character of the ECG signal. This is evident by the spatially random order of frontal leads and the absence of ST depression in the criteria. However, it has been shown that posterior infarctions induce ST currents in the posterior direction away from the precordial electrodes, typically resulting in ST depression in leads V3-V4. Wung and Drew have shown a notable increase in sensitivity to posterior infarctions by applying ST elevation criteria to recordings of the 12 standard leads plus posterior leads V7-V9 (8). The V7-V9 electrodes are placed on the back of the torso and record ST currents in the posterior direction as ST elevation. Posterior infarctions thus meet the criteria of ST elevation in V7-V9. In addition, a recent clinical study by Martin et al. showed that STEMI equivalent criteria incorporating both ST elevation and ST depression in the 12 standard leads significantly increase the diagnostic sensitivity to posterior infarctions (9). The two studies indicate that posterior lead ST elevation and anterior lead ST depression are associated phenomena in most cases of posterior infarction. Recently, Swedish researchers have introduced a 24-lead ECG (6, 10), where the 12 standard leads are complemented by their negative counter-part (i.e. −I, −II, −aVR etc.). The limb leads were presented in a spatially ordered sequence, based on the Cabrera sequence [5] which has been in use in Sweden since the 1970s. The 24-lead ECG produces a spatially ordered ECG, covering the entire 360° arc of both the frontal and horizontal planes (6).

Although the 24-lead ECG does not comprise more information than the 12-lead ECG (11), the concept is clinically interesting because it solves the contiguity problem of the current STEMI criteria by presenting the leads in a spatial order, visualizing ST deviation in different directions in the frontal and horizontal planes. At the same time it creates leads that will show ST elevation where its counterpart in the opposite direction shows ST depression. Thus any ST deviation will fulfill the criteria of ST elevation in either one lead or the other.

The efforts to “spatialize” the ECG immediately direct the attention to a vectorial representation of ST deviation. The concept of vector electrocardiography was founded on the work by Wilson and co-workers describing the electrical wavefront with direction and magnitude (12). The spatial vector concept was introduced and formalized by R. P. Grant in the early 50's (13), modelling the electrical activity of the heart at any given time during the cardiac cycle as a spatial dipole vector with direction and magnitude and the leads as linear projections of this dipole.

Recently, Hurst described ST deviations as projections of an ST injury current vector created by areas of myocardial ischemia, which adds to the normal electrical activity of the heart. Following this reasoning the ST injury vector may give elevation in some leads and simultaneous depression in other leads. Using Grant's vectorial approach a rough estimate of the direction and magnitude of this ST injury vector can be made, thus giving an estimate of the degree and location of myocardial ischemia [10, 11].

Clinical practice of estimation of the location of ischemia has resulted in a number of rules, mapping the myocardium by grouping the 12 standard leads in anterior leads, lateral leads and inferior leads. However, this spatial interpretation of ST deviations is incomplete and ignores the fact that all leads give useful information about the direction and size of the ST injury vector.

In the present work, we introduce the ST Compass as a way of visualizing the spatial extent and contiguity of ST deviations. Furthermore, we present a technique for estimation of the ST injury vector from ST deviation measurements and present results from two cases of acute myocardial infarction.

### Methods:

### Basic Concepts

The basic idea behind the ST Compass is to visualize the ST deviations in both size and direction—i.e. as vectors in space. The spatial representation is based solely on actual ST measurements from the standard 12 lead ECG and does not rely on mathematical transformations as know from inverse Dower, reduced lead sets etc.

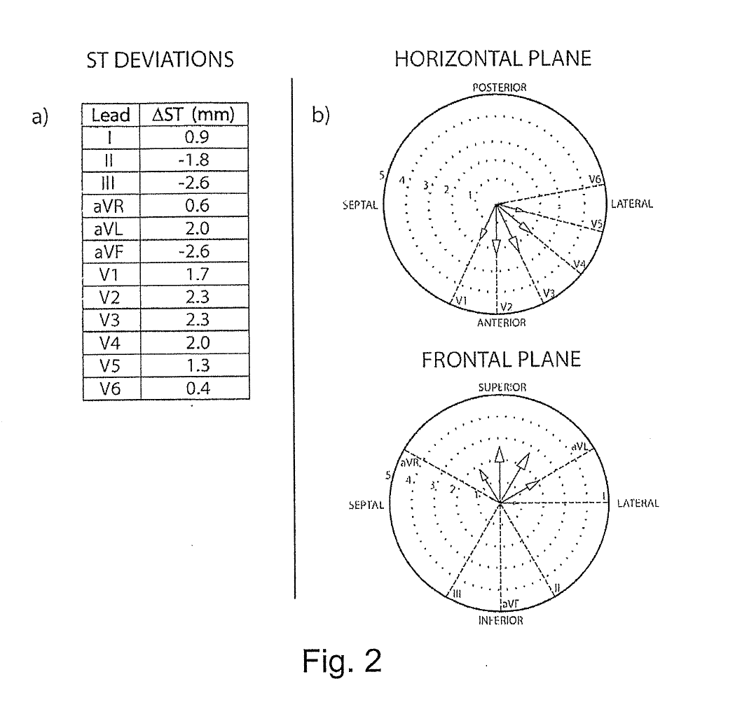

The spatial direction of the 12 standard leads can be presented visually in two different ways: Either as vectors in one 3D space or as vectors in two orthogonal 2D planes. The 3D approach is comprehensive and well-suited for computer-based visualization, where it is possible to turn objects and sense the spatial character of the model. However, to ensure the compatibility of the ST Compass with the existing ECG media and allow for easy integration in clinical practice the ST Compass presents spatial vectors in two 2D planes, following the usual grouping of the 12 standard leads: Limb leads and augmented leads (I-III, aVR-aVF) oriented in the frontal plane and precordial leads (V1-V6) oriented in the horizontal plane as shown in FIG. 2. Conceptually, the centre of the ST Compass is located in the centre of the left ventricle (6, 10, 14).

In the frontal plane, the Northern direction is superior and the Southern direction is inferior. In the horizontal plane, the Northern direction is posterior and the Southern direction is anterior. In both planes, East constitutes the lateral direction and West constitutes the septal direction (6, 10).

Each compass comprises five concentric circles representing 1, 2 3, 4 and 5 mm ST deviation (i.e. 0.1-0.5 mV) respectively. The centre of the circles denotes 0 mm ST deviation. For each of the 12 leads there is a dashed line from the centre of the circles towards the positive pole of the specific lead—in the precordial case that is towards the electrode position on the torso. The dashed line indicates the spatial direction of each lead in the appropriate plane. Limb leads and augmented leads are shown in the frontal plane at 0° (I), −60° (II), −120° (III), 150° (aVR), 30° (aVL) and −90° (aVF). The precordial leads are shown in the horizontal plane at −115° (V1), −90° (V2), −65° (V3), −40° (V4), −15° (V5) and 10° (V6) to obtain an even angular spacing of 25° between leads, to let V2 point in the anterior direction) (−90°, to let V5 point slightly anterior of the midaxial line and let V6 point slightly posterior to this line (6, 10, 14).

For each lead the measured ST deviation is indicated with an arrow originating in the centre of the compass and pointing in the direction of the respective lead. In the case of ST elevation, the arrow is drawn in the direction of the positive pole of the lead (same direction as the dashed line), but in the case of ST depression the arrow is drawn in the opposite direction, away from the positive pole and opposite the dashed line representing the lead direction. The length of the arrow is determined by the size of the measured ST deviation in the specific lead measured on a continuous scale. The procedure is exemplified in FIG. 2, which shows a pattern in the frontal plane, where ST elevation in leads I, aVR and aVL are evidently associated with the ST depression in leads II, III and aVF. It may be difficult to assess this association of leads mentally, but the spatial visualization of the ST Compass clarifies the pattern.

This association of ST elevation and ST depression plays a central role in the interpretation of the ECG in a spatial fashion. Under the assumption that the ST deviations are caused by an extra dipole source, i.e. the ST injury current, all ST deviations will be projections of this dipole in the directions of the respective leads. The spatial pattern of ST elevation and ST depressions as shown in FIG. 2 may therefore be interpreted as a number of projections of an ST injury current vector pointing superior and anterior with a magnitude of 0.2-0.3 mV.

### ST Injury Vector Estimation in 3D

ST deviation measurements supply information on the direction and magnitude of the projections of the ST injury vector and enable us to estimate the actual extent of the ST injury vector in 3D. A procedure to make this estimation using the ST Compass is the following:

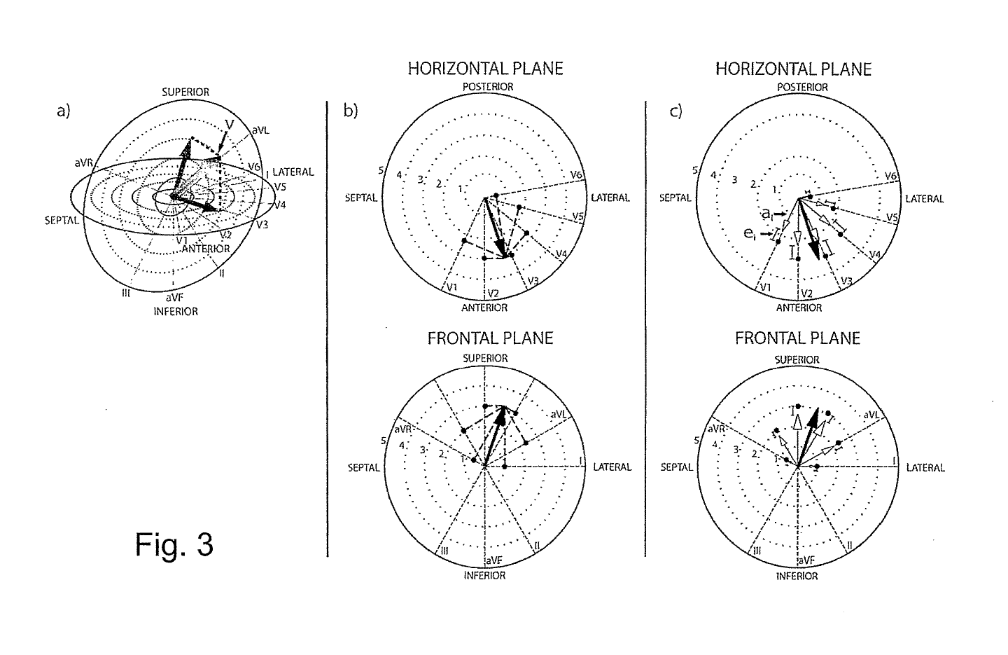

The ST injury vector is a single 3D vector that, when projected on each of the leads, best describes the observed vectors in the leads (FIG. 3). Mathematically, the lengths or amplitudes αᵢ of the observed vectors can be calculated by projecting the injury vector v on the respective lead vector lᵢ: αᵢ=v·lᵢ+eᵢ, where v·lᵢ is a scalar product (projection) of the injury vector with the lead vector lᵢ, and eᵢ is an error term because a single injury vector will not fit exactly all observed leads. v is now chosen such as to minimize the sum of the squared errors over all the leads to obtain the best fitting injury vector. The calculations to obtain this vector are exactly the same as in a multiple regression.

### Case Data

To exemplify the use of the ST Compass we will present two cases of Acute Myocardial Infarction (AMI).

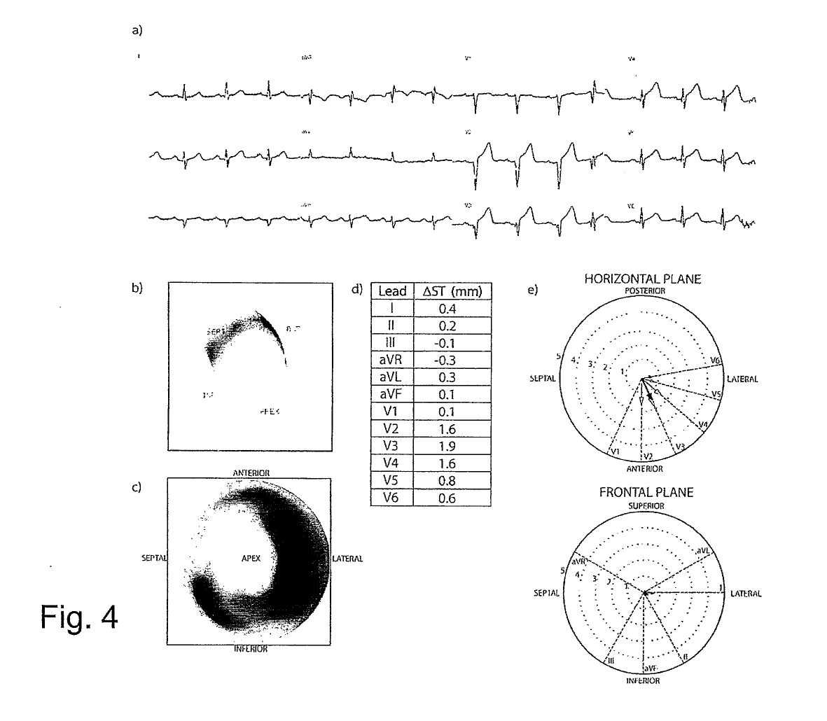

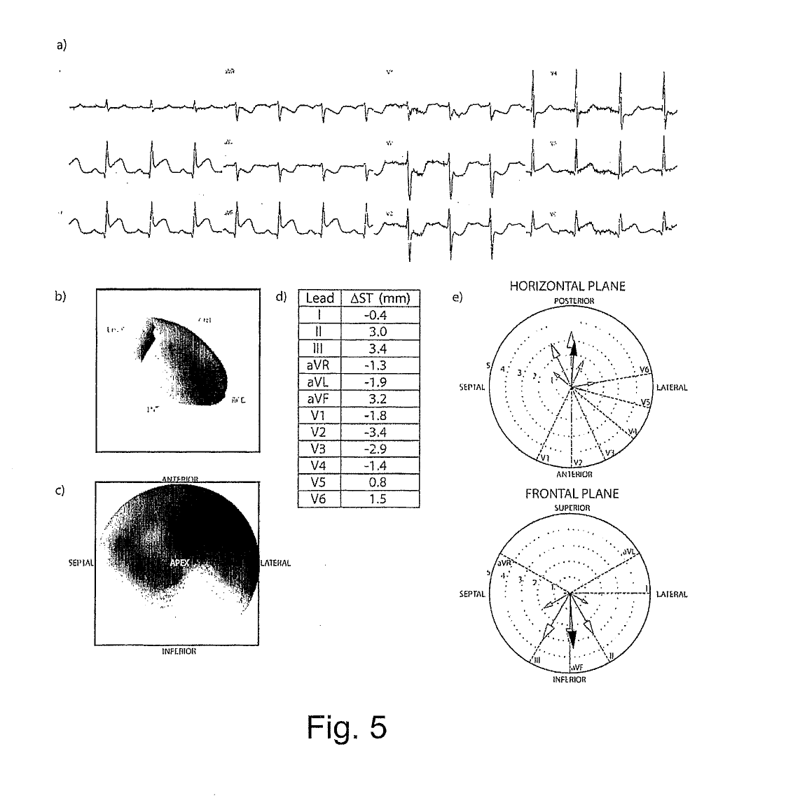

Both patients were hospitalized with symptoms of AMI. During ambulance transportation a prehospital diagnosis of STEMI was made and the patients were redirected to a Regional Heart Centre for primary percutaneous coronary intervention (PPCI). The 10 second ECGs presented in FIGS. 4 and 5 were recorded during coronary angiography (CAG) immediately prior to balloon inflation and TIMI flow was registered concurrently.

ECGs were recorded using a Lifepak-12 emergency care monitor (Medtronic Emergency Response Systems, Redwood, WA). Data were transferred to a PC for post-processing using GE Research Workstation Software (GE Healthcare, Milwaukee, Wis.). The software was used to form a median beat in every lead based on 10 second recordings. ST deviation measurements were performed automatically in the J-point on the median beat. ST deviation measurements were processed automatically using custom software developed in Matlab 2007b (The Mathworks, Natick, Mass.) to generate ST Compass plots and estimate ST injury current vectors as described above.

Before coronary intervention patients received an intravenous injection of 700±10% MBq^{99m}Tc-Sestamibi to assess the area at risk (AAR). Imaging was performed within 2 hours using a dual-headed rotating gamma camera (ADAC) with a high-resolution, parallel-holed collimator. Sixtyfour projections of 25 seconds were acquired over a noncircular 180° arc.

Three cardiology experts evaluated the ECGs independently of each other and then agreed on a consensus classification of the location of the infarction using the labels “anterior”, “posterior”, “lateral”, “septal”, “superior”, “inferior” or any combination of these. The experts considered any ST deviation in any lead relevant in their interpretation of the ECGs. The cardiologists did not have access to CAG- or SPECT-images.

### Results:

### Case 1:

Results from Case 1 are presented in FIG. 4.
Case 1 is a 57-year old male. CAG showed one-vessel disease with occlusion of the left anterior descending artery (LAD) resulting in TIMI-flow 0 immediately prior to intervention.

The ACC/ESC STEMI criteria are not met by the patient's ECG, since no ST elevation of >2 mm is present in V2-V3 and only one additional lead, lead V4, shows >1 mm ST elevation. Furthermore, the ECG shows signs of a single premature ventricular complex (PVC) at the end of the V1-V3 tracings shown in FIG. 4 (a).

The expert cardiologists agreed on a classification of “antero-lateral infarction” based on ST elevations in the anterior and lateral precordial leads.

SPECT-imaging showed myocardial ischemia in the apical part of the left ventricle with a slight anterior extent.

In the ST Compass the ST elevations in leads V2-V6 form a distinct pattern in the antero-lateral direction in the horizontal plane. There are no significant ST deviations in the frontal plane compass. The estimated ST injury vector points antero-lateral (in the direction of lead V3) with a magnitude of 1.5 mm (0.15 mV).

### Case 2:

Results from Case 2 are presented in FIG. 5.

Case 2 is a 62-year old male. CAG showed one-vessel disease with occlusion of the right coronary artery (RCA) resulting in TIMI-flow 0 immediately prior to intervention.

The ACC/ESC STEMI criteria were met by the patient's ECG, which showed ST elevation of >1 mm in the three contiguous leads II, aVF and III.

The expert cardiologists agreed on a classification of “postero-infero-lateral infarction” based on ST elevations in the inferior limb/augmented leads (II, aVF, III), ST deviation in the anterior precordial leads (V1-V3) and ST elevation in the lateral precordial leads (V5-V6).

SPECT-imaging showed myocardial ischemia in the basal part of the left ventricle and on the inferior wall.

In the ST Compass, the ST depressions in leads V1-V4 and the ST elevations in leads V5-V6 form a distinct pattern in the posterior direction in the horizontal plane. ST elevations in leads II, aVF and III and ST depressions in leads aVR and aVL form a distinct pattern in the inferior direction in the frontal plane. The estimated ST injury vector points postero-inferior with a magnitude of 4.4 mm (0.44 mV).

### Discussion:

The ST Compass provides a concise, spatial visualization of measured ST deviations and clarifies contiguity of ST elevations and ST depressions to the user. The ST Compass is based on existing lead configurations and ST measurements, making it fully compatible with existing ECG standards and media. The performance of the ST Compass is illustrated by the two AMI cases presented.

In Case 1, the ST Compass shows a distinct pattern in the horizontal plane resulting in an ST injury vector estimation in the antero-lateral direction. These findings are in full agreement with occlusion of the LAD as shown by CAG, the expert consensus and the SPECT images showing myocardial ischemia in the apical region of the left ventricle. The magnitude of the ST injury vector estimate is slightly smaller than the maximal ST elevation in the horizontal plane. This attenuation is caused by the absence of ST deviation in the lateral direction in the frontal plane which would have been expected by the lateral ST deviations in the horizontal plane. Producing separate estimates for each of the two planes could be considered. However, this conflicts with the concept of one, global ST injury vector being responsible for all ST deviations. Future work will show if the global estimate deviates significantly from separate horizontal and frontal plane estimates.

In Case 2, the ST Compass shows a clear pattern of ST deviations in the inferior and posterior directions giving rise to an ST injury vector estimate in the infero-posterior direction. This is consistent with occlusion of the RCA as shown by CAG and the SPECT images showing ischemia in the basal portion and inferior wall of the left ventricle.

The direction of the ST injury vector estimate is not consistent with the expert consensus of “postero-infero-lateral infarction” for Case 2. The large ST elevation in lead II may be interpreted as indicating a lateral extent of the infarction. However, when inspecting the ST deviations spatially in the ST Compass, it is clear that the elevation in lead II is more likely a projection of the large inferior ST injury vector. The magnitude of the ST injury vector is 4.4 mm and hence much larger than the maximal ST deviation measured on the ECG.

This is an example of how the direction of the ST injury current with respect to the standard leads may be important for the size of the measurable ST deviations. The magnitude of the ST injury vector estimate, however, is conceptually independent of the direction of the current with respect to the leads and this may show to be advantageous in comparison to the existing STEMI criteria.

An example: 1 mm ST elevation is measured in the three orthogonal axes leads V2, I and aVF (X,Y,Z). By simple geometry the 3D-magnitude of the ST injury vector would then be:

ST injury magnitude=\sqrt{(ST_{X}²+ST_{Y}²+ST_{Z}²)}=\sqrt{(1²+1²+1²)}=1.7mm.

This is significantly more than the 1 mm that is measurable in the individual leads, because the ST injury direction matches poorly with the lead directions. If an ST injury vector of similar magnitude points directly towards the V2 electrode in the horizontal plane, an ST elevation of 1.7 mm would be registered in V2. In this way the same magnitude of injury current can result in different ST deviation magnitudes on the ECG depending on the direction of the ST injury vector.

In both cases the ST injury vector points towards the area of myocardial ischemia, which is consistent with the statement by Hurst that “the mean spatial vector points toward predominant epicardial injury” (2, 3).

Generally, the ST Compass is based on the Swedish approach—to visualize the ECG in a spatial fashion. In contrast to the 24-lead ECG presented by Perron and colleagues (6) the ST Compass is concise and can be printed on a standard ECG tracing along with the diagnostic statements in the upper part of the paper. Likewise, it can be shown directly on monitors and electrocardiographs without changing the standard view of the 12-lead ECG.

Inside the ST Compass, we find a simple dipole model of the cardiac electrical activity propagating through a homogenous conductor torso model. These assumptions underlie the geometrical interpretation of ST deviations and the method used for estimating the ST injury vector. Though this model represents a very simplified view of the ECG it is in excellent agreement with everyday clinical ECG interpretation. The model may be improved with more precise lead directions, conductance of torso tissue etc. Still the main clinical strength of the ST Compass must be maintained: An intuitive, uncomplicated spatial interpretation of ST deviations.

The normal range of ST injury magnitude should be investigated in a large population to define relevant criteria for diagnostic use of the method. Furthermore, it should be investigated deeper whether the direction of the ST injury vector is indeed associated with the location of myocardial ischemia as indicated by the case results presented here.

The vectorial approach to ST deviation interpretation may be useful for the discrimination between ST depression caused by posterior infarctions and ST depression caused by subendocardial ischemia (true non-STEMI). Hurst states that the ST injury vector points towards areas of endocardial ischemia (transmural ischemia) and away from areas of subendocardial ischemia (non-transmural ischemia)(2, 3). Shah et al. state that “Complete acute occlusion of a major coronary artery typically produces a ST segment deviation pattern specific for the location of the occlusion. Conversely, non-occlusive ischemia produces a diffuse ST segment depression pattern that is not specific for the myocardial location of the ischemia.”(4)

The ST Compass may be a tool to test the hypothesis stated by Shah et al. and establish a method for differentiation between occlusive and non-occlusive ischemia from the surface ECG.

### CONCLUSION

The ST Compass provides a concise, spatial visualization of ST deviations and clarifies spatial contiguity of leads. It can be used to estimate a spatial ST injury vector describing the spatial direction and magnitude of the ST injury current caused by myocardial ischemia. The ST injury vector magnitude is conceptually independent of the ST current direction and may form the basis for new AMI-criteria that are independent of discussions on elevation, depression and lead contiguity. Further studies are required to assess the clinical usefulness of the method and the characteristics of the ST injury vector in myocardial infarction of occlusive and non-occlusive etiologies.

### REFERENCES

### Cited Above in Parentheses

1. Thygesen K, Alpert J S, White H D, et al. Universal Definition of Myocardial Infarction. Circulation 2007; 116:2634.
2. Hurst J W. Thoughts about the abnormalities in the electrocardiogram of patients with acute myocardial infarction with emphasis on a more accurate method of interpreting S-T segment displacement: Part II. Clin Cardiol 2007; 30:443.
3. Hurst J W. Thoughts about the abnormalities in the electrocardiogram of patients with acute myocardial infarction with emphasis on a more accurate method of interpreting S-T segment displacement: part I. Clin Cardiol 2007; 30:381.
4. Shah A, Wagner G S, Green C L, et al. Electrocardiographic differentiation of the ST segment depression of acute myocardial injury due to the left circumflex artery occlusion from that of myocardial ischemia of nonocclusive etiologies. Am J Cardiol 1997; 80:512.
5. Dower G E, Machado H B, Osborne J A. On deriving the electrocardiogram from vectorcardiographic leads. Clinical Cardiology 1980; 3:87.
6. Perron A, Lim T, Pahlm-Webb U, et al. Maximal increase in sensitivity with minimal loss of specificity for diagnosis of acute coronary occlusion achieved by sequentially adding leads from the 24-lead electrocardiogram to the orderly sequenced 12-lead electrocardiogram. J Electrocardiol 2007; 40:463.
7. Wagner G, Lim T, Gettes L, et al. Consideration of pitfalls in and omissions from the current ECG standards for diagnosis of myocardial ischemia/infarction in patients who have acute coronary syndromes. Cardiol Clin 2006; 24:331.
8. Wung S F, Drew B J. New electrocardiographic criteria for posterior wall acute myocardial ischemia validated by a percutaneous transluminal coronary angioplasty model of acute myocardial infarction. Am J Cardiol 2001; 87:970.
9. Martin T N, Groenning B A, Murray H M, et al. ST segment deviation analysis of the admission 12-lead electrocardiogram as an aid to early diagnosis of acute myocardial infarction with a cardiac magnetic resonance imaging gold standard. J Am Coll Cardiol 2007; 50:1021.
10. Pahlm-Webb U, Pahlm O, Sadanandan S, et al. A new method for using the direction of ST segment deviation to localize the site of acute coronary occlusion: The 24-view standard electrocardiogram. Am J Med 2002; 113:75.
11. Kligfield P. How many leads are in the 12-lead electrocardiogram, and what does that mean for the diagnosis of acute ST-elevation myocardial infarction? J Electrocardiol 2007; 40:472.
12. Wilson F N, Macleod A G, Barker P S. The interpretation of the initial deflections of the ventricular complex of the electrocardiogram. Am Heart J 1931; 6:637.
13. Grant RP. An Approach to the Spatial Electrocardiogram. Am Heart J 1950; 39:17.
14. Anderson S T, Pahlm O, Selvester R H, et al. Panoramic Display of the Orderly Sequenced 12-Lead Ecg—Position Paper. J Electrocardiol 1994; 27:347.

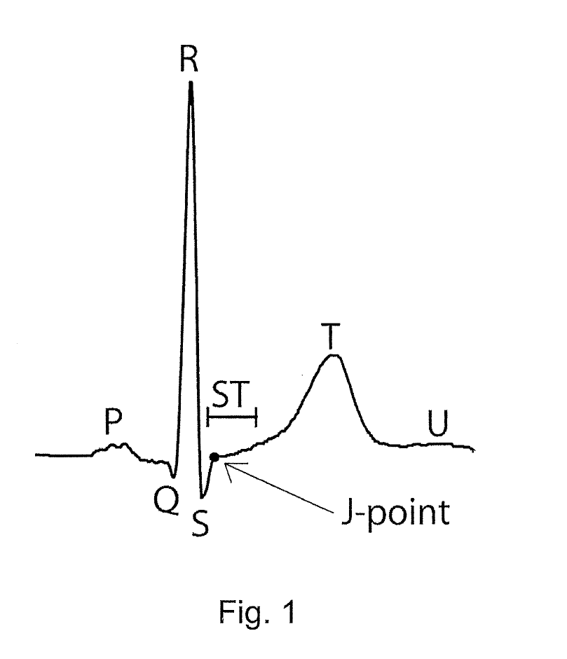

FIG. 1 shows an electrocardiographic display of a single heart beat. The different waves of the curvature are named P wave, Q wave, R wave, S wave, T wave and U wave. The segment between the end of the S wave and the beginning of the T wave is called the ST segment. The voltage level of the ST segment is often measured in the J-point.

FIG. 2 shows ST deviation measurements presented in panel a) are drawn as arrows in the ST Compass in panel b). ST elevations are drawn as arrows pointing in the positive lead direction and ST depressions are drawn as arrows pointing in the opposite direction of the positive lead pole. The length of the arrow corresponds to the magnitude of the ST deviation in the respective lead.

FIG. 3 shows the 3D ST injury vector v in a) is projected on each of the leads in the two planes in b). The projections are shown as dots in panel c) and compared to the actual ST deviation measurements in each lead aᵢ indicated by arrows in panel c). The error eᵢ between the projections resulting from the ST injury vector estimate and the actual ST deviation measurements are evaluated for each lead i and v is chosen to minimize the error and create an optimal estimate of the ST injury vector.

FIG. 4 shows results for Case 1. a) 12 lead ECG tracing. b) 3D SPECT image from a septal perspective. c) SPECT image, apical bulls-eye plot. d) ST deviation measurements lead-by-lead. e) The ST Compass showing ST deviations as hollow arrows and projections of the ST injury vector estimate as solid arrows.

FIG. 5 shows results for Case 2. a) 12 lead ECG tracing. b) 3D SPECT image from a septal perspective. c) SPECT image, apical bulls-eye plot. d) ST deviation measurements lead-by-lead. e) The ST Compass showing ST deviations as hollow arrows and projections of the ST injury vector estimate as solid arrows.

1. System for spatial estimation of multi-lead electrocardiographic ST deviations, in which system a plurality of ECG signals are recorded from a ECG source, which signals are stored by a processor in a memory, which processor processes the signals to obtain ST deviation, which processor performs measurement of ST deviation from each lead, characterized in that the processor performs a multi-dimensional estimation of a vector representing the spatial direction and magnitude of the underlying cardiac injury-current giving rise to the measured ST deviations.

2. System according to claim 1, characterized in that the processor performs a spatial visualization of the vector representing the spatial direction and magnitude of the underlying cardiac injury-current giving rise to the measured ST deviations in the spatially distributed electrocardiographic leads.

3. System according to claim 2, characterized in that the processor uses the recordings of the ECG signals to form a graphical display of vectors representing the magnitude of each ST deviation in the spatial direction of the lead from which the measurement was made.

4. System according to claim L characterized in that the ST deviation recordings are processed in the processor to estimate an overall ST injury current vector, which ST injury current vector numerically fits the single ST deviation vectors, when the single ST deviation vectors are considered projections of the overall ST injury current vector onto vectors in the spatial direction of each single lead.

5. System according to claim 4, characterized in that the degree to which the ST injury current vector estimate explains the observed ST deviation vectors is evaluated which ST injury current vector estimate is displayed to indicate the extent and location of myocardial ischemia.

6. System according to claim 3, characterized in that the system supports the clinical interpretation of ST segment changes by presenting ST deviation measurements as spatial vectors and estimating an overall ST injury current vector.

7. System according to claim 6, characterized in that by displaying ST deviation vectors in a spatially ordered fashion, the system facilitates the correct interpretation of lead contiguity in the interpretation of the ECG.

8. System according to claim 7, characterized in that the direction of ST deviation vectors defined by positive ST deviation values (ST elevation) are defined as a vectors pointing towards the positive pole of the lead in question, where the direction of ST deviation vectors defined by negative ST deviation values (ST depressed) are defined as a vector pointing towards the positive pole of the lead in question.

9. System according to claim 6, characterized in that the ST deviation vectors and the overall ST injury current vectors is displayed graphically in a two or three-dimensional form.

10. System according to claim 9, characterized in that the two-dimensional form consist of two two-dimensional coordinate systems, which two coordinate system covers two orthogonal planes, such as the frontal and horizontal planes, that fully describe the entire three-dimensional character of the vectors.

11. System according to claim 10, characterized in that each ST deviation vector is projected onto each of the two planes covered by the two coordinate systems and displayed in each of the coordinate systems as an arrow pointing from the origin of the relevant coordinate system in the direction and magnitude defined by its projection coordinates.

12. System according to claim 9, characterized in that the three-dimensional form consist of a three-dimensional coordinate system where each ST deviation vector is displayed as an arrow pointing from the origin of the coordinate system in the direction and magnitude defined by its coordinates.

13. System according to claim 11, characterized in that in order to facilitate reading of the ST deviation vector magnitude each of the two and three-dimensional coordinate system includes a scale, which scale is displayed as concentric circles surrounding the origin of the coordinate system.

14. System according to claim 13, characterized in that the scale that is displayed comprises direction labels to indicate the anatomical direction of each of the coordinate system axes.

15. System according to claim 4, characterized in that the ST injury current vector is a single 3D vector, which single 3D vector is projected on each of the leads, where the lengths or amplitudes αᵢ of the observed ST deviation vectors is mathematically calculated by projecting the ST injury current vector v on the respective lead vector lᵢ: αᵢ=v·lᵢ+eᵢ, where v·lᵢ is a scalar product (projection) of the ST injury current vector with the lead vector lᵢ, and eᵢ is an error term because a single ST injury current vector will not fit exactly all observed leads. v is now chosen such as to minimize the errors over all the leads to obtain the best fitting ST injury current vector.

16. System according to claim 15, characterized in that error terms for the best fitting ST injury current vector estimate is used as an indicator of the degree to which the single ST injury current vector estimate is used to explain the observed ST deviations.

17. System according to claim 16, characterized in that by evaluating a goodness-of-fit of the ST injury current vector with respect to the observed ST deviations, and by defining a level of threshold the goodness-of-fit estimate is used to categorize the condition as ‘normal’, ‘STEMI’, ‘true non-STEMI’ or similar, where the goodness-of-fit estimate as well as the category label is displayed graphically.

18. System according to claim 4, characterized in that the ST injury current vector estimate is used to categorize the location and extent of myocardial ischemia, the location and the extend is calculated by the computer by defining a threshold for the magnitude of the ST injury current vector, which threshold is used to categorize the condition indicated by the ST injury current vector as normal or indicative of a certain degree or extent of myocardial ischemia.

19. System according to claim 4, characterized in that the direction of the ST injury current vector is used to categorize the location of a possible ischemic area, the computer defines a number of direction zones in the relevant coordinate system used, to allow for anatomical positioning of the suspected ischemic myocardial area.

20. Method for spatial estimation of multi-lead electrocardiographic ST deviations, by which method a plurality of ECG signals are recorded from a ECG source, which ECG signals are stored by a processor in a memory, which processor processes the signals to obtain ST deviation, which processor performs measurement of ST deviation from each lead, characterized in that the processor performs a multi-dimensional estimation of an vector representing of the spatial direction and magnitude of the underlying cardiac injury-current giving rise to the measured ST deviations.

21. Method for spatial visualization of multi-lead electrocardiographic ST deviations, by which method a plurality of ECG signals are recorded from a ECG source, which ECG signals are stored by a processor in a memory, which processor visualize the ECG signals to visualize ST deviation, which processor performs visualization of the ST deviation from each lead, characterized in that the direction of ST deviation vectors is visualized by positive ST deviation values as ST elevation is disclosed as vectors pointing towards the positive pole of the lead in question, where the direction of ST deviation vectors is visualized by negative ST deviation values as ST depressed is disclosed as a vector pointing towards the negative pole of the lead in question.

22. Method according to claim 20, characterized in that the ST deviation vectors and a overall ST injury current vectors is visualized graphically in a two or three-dimensional form.

23. Method according to claim 22 characterized in that a two-dimensional visualization is performed by two two-dimensional coordinate systems, which two coordinate system covers two orthogonal planes, such as a first frontal and a second horizontal planes, which planes fully describe the entire three-dimensional character of the vectors.

24. Method according to claim 23, characterized in that each ST deviation vector is projected onto each of the two planes covered by the two coordinate systems and visualized in each of the coordinate systems as an arrow pointing from the origin of the relevant coordinate system in the direction and magnitude defined by its projection coordinates.
